(19) United States
(12) Patent Application Publication
(10) Pub. No.: US 2003/0058441 A1
(43) Pub. Date: Mar. 27, 2003

(54) Method and apparatus for optical measurements

(75) Inventors: John Shakespeare, Siuro (FI); Tarja Shakespeare, Siuro (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy,, Tampere (FI)

(21) Appl. No.: 09/957,085

(22) Filed: Sep. 20, 2001

(51) Int. Cl. G01J 3/42

(52) U.S. Cl. 356/319

(57) ABSTRACT

The invention relates to a method and an apparatus according to the method. A sample is illuminated by a band of optical radiation the illumination state of which is variable as a function of time. Reference measurements of the spectrum of the optical band illuminating the sample are made at least at three separate instants of time. A spectrum of a band of the optical radiation that has interacted with the sample is measured at the corresponding separate instants of time as the reference measurement, and the radiance transfer factor matrix of the sample is estimated from the set of reference measurements and the set of sample measurements.

### FIELD OF THE INVENTION

The present invention relates to optical measurements, particularly to spectral reflectance or transmittance measurements for fluorescent materials.

### BACKGROUND OF THE INVENTION

Spectroscopic measurements employing a non-monochromatic light source are of total radiance factor, which is equal to the reflectance or transmittance only in the absence of fluorescence. It is the practice in industry to refer to the measurements of the total radiance factor as reflectance or transmittance measurements, although “apparent reflectance” and “apparent transmittance” would be more appropriate. When fluorescence is present, the apparent reflectance and apparent transmittance are dependent on the spectral power distribution of the optical power source. The combination of reflection and fluorescent emission is commonly referred to as remission, and the combination of reflected and emitted radiances is commonly referred to as remitted radiance.

The variation of apparent reflectance in different conditions of illumination is quantified by making measurements when the material is illuminated with several different optical power sources, or with a single wide band illuminant using each of several filters for generating different optical bands. Alternatively, the emissivity or transmissivity may be measured by making measurements when the material is illuminated with each of several essentially monochromatic optical power sources.

In measuring with a plurality of non-monochromatic conditions of illumination, the difference between the spectral power distributions of the conditions of illumination is critical, and must be predetermined before measurements. Among other requirements, optical power sources of high stability are then mandatory. That results in high cost of components. In all cases using non-monochromatic optical power sources, however, either a plurality of stable optical power sources, or one stable optical power source with one or more switchable optical filters of known characteristics is required to provide different predetermined states of illumination. Since prior art methods employing non-monochromatic illuminators cannot fully separate the effects of fluorescence from the effects of reflectance or transmittance, the optical filters are customarily chosen so as to approximate a particular standard state of illumination using the actual light source. In other cases, a second light source is used alternatively to or in combination with the first light source to more accurately approximate the desired standard conditions of illumination. In either case, stability of the one or more light sources is required, and precise control over the intensity and the spectral power distribution of the one or more light sources. Moreover, the effects of fluorescence are not fully distinguished from the effects of reflectance or transmittance, and are not characterized in an illuminator-independent way. Thus, the total radiance factors, or apparent reflectance or apparent transmittance, can be reliably estimated only for conditions of illumination which are similar to one of the actual conditions of illumination. Also some averaging over a plurality of measurements in each state is required to overcome intrinsic variation (non-repeatability) in each state. A requirement for predetermined non-monochromatic conditions of illumination is not technically feasible, and therefore solutions aiming at the creation of or presupposing such a situation for the measurement do not yield reliable measurement information.

The solution using monochromatic optical power sources avoids these problems, but requires a large number of optical power sources with a predetermined wavelength and related components, or utilization of a monochromator to produce predetermined wavelengths. Moreover, since a monochromatic illuminator cannot use high power levels in practice, a stimulated fluorescent emission is of low power and requires averaging over long measurement times or over several sequential measurements to give a single reliable measurement. That results also in high cost of components and the whole apparatus.

### BRIEF DESCRIPTIONS OF THE INVENTION

An object of the invention is thus to implement an improved method and an apparatus implementing the method in which the need for a precise and predetermined illumination state is avoided. This is achieved by a method for performing an optical measurement comprising: illuminating a sample by a band of optical radiation the illumination state of which is variable as a function of time; performing reference measurements by measuring the spectrum of the optical band illuminating the sample at least at three separate instants of time; measuring a spectrum of a band of the optical radiation that has interacted with the sample at the corresponding separate instants of time as the reference measurement; and estimating the radiance transfer factor matrix of the sample from the set of reference measurements and the set of sample measurements.

The invention also relates to an apparatus for performing an optical measurement comprising: at least one optical power source for illuminating a sample by a band of optical radiation the spectral illumination state of which is variable as a function of time; means for measuring the spectrum of the optical band illuminating the sample at least at two separate instants of time as a reference measurement; means for measuring a spectrum of a band of the optical radiation that has interacted with the sample at the corresponding separate instants of time as the reference measurement; and means for estimating the radiance transfer factor matrix of the sample from the set of reference measurements and the set of sample measurements.

Preferred embodiments of the invention are disclosed in the dependent claims.

The invention is based on measuring the illumination state from both the radiation directed onto the sample and the radiation that has interacted with the sample, using an optical power source the optical output of which changes as a function of time. Comparison of spectral power distributions at different instants of time allows definition of fluorescent and non-fluorescent optical properties of the sample.

Several advantages are achieved by means of the method and arrangement according to the invention. A stable optical power source is neither required nor desired. Instability of the optical power source, especially a flash lamp, is a virtue rather than an impediment with the benefit that a less expensive optical power source can be used. The number of optical components is reduced, since in many cases only one optical power source is required, with no moveable filters or arrangements for stabilizing optical power sources, or arrangements for approximating particular standard illuminants. In this way, the complexity and cost of the measuring system are greatly reduced and the system employs fewer and less complex optical components. Furthermore, the invention allows the effects of fluorescence to be distinguished from the effects of reflectance or transmittance, and to be characterized in an illuminator-independent way, without relying on monochromatic illumination. This allows the total radiance factors, or apparent reflectance or apparent transmittance, to be calculated for arbitrary conditions of illumination, which can differ from any of the actual conditions of illumination.

### BRIEF DESCRIPTION OF THE DRAWINGS

The invention will now be described in greater detail in connection with preferred embodiments, with reference to the attached drawings, in which

FIG. 1 shows a block diagram of a measuring apparatus;

FIG. 2 shows a block diagram of a measuring apparatus;

FIG. 3 shows a measuring apparatus with one optical power source;

FIG. 4 shows a measuring apparatus with two optical power sources;

FIG. 5 shows a measuring apparatus which measures both reflected and transmitted radiation;

FIG. 6 shows a spectral power distribution of an optical power source;

FIG. 7 shows a spectral power distribution measured from a fluorescent white sheet;

FIG. 8 shows a spectral power distribution measured from a non-fluorescent blue sheet;

FIG. 9 shows a spectral power distribution measured from a fluorescent orange sheet;

FIG. 10A shows the real radiance transfer factor of a fluorescent white sheet;

FIG. 10B shows an estimated radiance transfer factor of a fluorescent white sheet;

FIG. 11A shows the real radiance transfer factor of a non-fluorescent blue sheet;

FIG. 11B shows an estimated radiance transfer factor of a non-fluorescent blue sheet;

FIG. 12A shows the real radiance transfer factor of a fluorescent orange sheet;

FIG. 12B shows an estimated radiance transfer factor of a fluorescent orange sheet; and

FIG. 13 shows an arrangement for measuring two-sided color of a material.

### DETAILED DESCRIPTION OF THE INVENTION

The above-described solution can be applied to the paper and process industry. However, it is not confined to these.

Let us first consider the relation between incident optical radiation and excident optical radiation (remitted or transmitted), which is known per se. The radiance factor is the ratio of radiance of a specimen to that of a perfectly reflecting or transmitting diffuser identically irradiated. The radiance transfer factor β(ζ, λ) is a radiance factor that accounts for the emittance on the wavelength λ of energy absorbed on the exciting wavelength ζ. The radiance transfer factor β(ζ, λ) depends on absorption, scattering and a quantum efficiency from each fluorescent excitation band to each fluorescent emission band. More generally, the excident radiation in each wavelength band depends on the incident radiation in that band, the incident radiation in all wavelength bands which excite a fluorescent emission in that band, the quantum efficiencies of such fluorescence, the characteristic optical paths for incident and scattered light in the substrate, and the amount and distribution of fluor in the substrate.

The multivariate model of the relation between incident optical radiation and excident optical radiation can be expressed in matrix form:

$${P}_{j} = {\sum }_{k = 1}^{k = M} {B}_{jk} {s}_{k} \qquad ( 1 )$$

where Pⱼ is the excident power in wavelength band j, sₖ is the incident power in wavelength band k, and Bⱼₖ is the radiance transfer factor from wavelength band k to wavelength band j. Equation (1) applies either to transmitted or remitted power, given the corresponding radiance transfer factor matrix B. Note that the matrix B in equation (1) is the discrete approximation to the radiance transfer factor β(ζ,λ), while P and s are discrete representations of the incident and excident radiant spectral power. We shall briefly describe the relation between B and β, and for clarity this will be expressed for the case of a prior art dual monochromator measurement, in which monochromatic incident radiation is produced by filtering a rich light source with a monochromator, and for each illumination condition the excident radiation is measured using a monochromator and detector at each of plural wavelengths.

In the case of ideal monochromators, where the incident band at wavelength ζₖ is of half width Δζₖ and the excident band at wavelength λⱼ is of half width Δλⱼ, then

$$\begin{matrix}{P}_{j} = {\int }_{{λ}_{j} - {Δλ}_{j}}^{{λ}_{j} + {Δλ}_{j}} P ( η ) ⅆ η & ( 2 ) \\ {s}_{k} = {\int }_{{ζ}_{k} - {Δζ}_{k}}^{{ζ}_{k} + {Δζ}_{k}} s ( ξ ) ⅆ ξ & ( 3 )\end{matrix}$$

where P(η) is the spectral power density of excident radiation at wavelength η, and s(ξ) is the spectral power density of the light source at wavelength ξ. In the non-ideal case, relations (2) and (3) are modified by the slit functions of the corresponding monochromators:

$$\begin{matrix}{P}_{j} = {\int }_{{λ}_{j} - {Δλ}_{j}}^{{λ}_{j} + {Δλ}_{j}} G ( η ; {λ}_{j} ) P ( η ) ⅆ η & ( 4 ) \\ {s}_{k} = {\int }_{{ζ}_{k} - {Δζ}_{k}}^{{ζ}_{k} + {Δζ}_{k}} F ( ξ ; {ζ}_{k} ) s ( ξ ) ⅆ ξ & ( 5 )\end{matrix}$$

where F(ξ;ζₖ) is the slit function used in filtering sₖ to produce a monochromatic incident radiation, and G(η;λⱼ) is the slit function used in measuring Pⱼ, and in this case, Δλⱼ and Δζₖ are the half widths of the corresponding slit functions. If the slit functions are known, then the P and s determined according to equations (4) and (5) can be used to estimate by deconvolution the P and s which would result in the ideal case of equations (2) and (3). Suitable methods for this deconvolution include van Clittert's method, the Richardson-Lucy or maximum entropy method, and numerous variations on these.

In the ideal case, the discrete approximation B to the radiance transfer factor β(ζ,λ) from wavelength ζ to wavelength λ is:

$${B}_{jk} = \frac{{\int }_{{λ}_{j} - {Δλ}_{j}}^{{λ}_{j} + {Δλ}_{j}} ⅆ η {\int }_{{ξ}_{k} - {Δζ}_{k}}^{{ξ}_{k} + {Δζ}_{k}} β ( ξ , η ) s ( ξ ) ⅆ ξ }{{\int }_{{λ}_{j} - {Δλ}_{j}}^{{λ}_{j} + {Δλ}_{j}} ⅆ η {\int }_{{ξ}_{k} - {Δζ}_{k}}^{{ξ}_{k} + {Δζ}_{k}} s ( ξ ) ⅆ ξ} \qquad ( 6 )$$

where Δζₖ and Δλⱼ, are the half widths of the incident and excident wavelength bands. In the non-ideal case, relation (6) is modified by the slit functions of the monochromators used to produce or measure the incident and excident radiation:

$${B}_{jk} = \frac{{\int }_{{λ}_{j} - {Δλ}_{j}}^{{λ}_{j} + {Δλ}_{j}} G ( η ; {λ}_{j} ) ⅆ η {\int }_{{ξ}_{k} - {Δζ}_{k}}^{{ξ}_{k} + {Δζ}_{k}} β ( ξ , η ) F ( ξ ; {ζ}_{k} ) s ( ξ ) ⅆ ξ }{{\int }_{{λ}_{j} - {Δλ}_{j}}^{{λ}_{j} + {Δλ}_{j}} G ( η ; {λ}_{j} ) ⅆ η {\int }_{{ξ}_{k} - {Δζ}_{k}}^{{ξ}_{k} + {Δζ}_{k}} F ( ξ ; {ζ}_{k} ) s ( ξ ) ⅆ ξ} \qquad ( 7 )$$

where F(ξ;ζₖ) is the slit function used in filtering sₖ to produce a monochromatic incident radiation, and G(η;λⱼ) is the slit function used in measuring Pⱼ, and in this case, Δλⱼ and Δζₖ are the half widths of the corresponding slit functions. In practice, equations (6) and (7) may not be needed. Rich light sources usually have smooth spectral power densities, and the half-widths of monochromators can be quite narrow in comparison to the spectral features of s(ξ) or β(ζ,λ). Thus, in most cases, the following approximation is adequate:

$${B}_{jk} = {\int }_{{λ}_{j} - {Δλ}_{j}}^{{λ}_{j} + {Δλ}_{j}} ⅆ η {\int }_{{ξ}_{k} - {Δζ}_{k}}^{{ξ}_{k} + {Δζ}_{k}} β ( ξ , η ) ⅆ ξ \qquad ( 8 )$$

where Δλⱼ and Δζₖ are the half widths of the corresponding slit functions.

We now return to the case of non-monochromatic illumination. From a single measurement of spectral power distribution of excident radiation, even if the spectral power distribution of incident radiation s is known, it is not possible to determine B, except in the trivial case where there is no fluorescence, and B is diagonal. Furthermore, it is not generally possible to ascertain that fluorescence is absent, although if the excident radiation in any band exceeds the incident radiation in that band, then fluorescence is present. Two or more different illumination conditions s⁽¹⁾ and s⁽²⁾ can be used to overcome the problem. The illumination conditions must differ in known ways in the absorption band of a fluorescent relation. From measurement of the reflected or transmitted optical radiation in each condition of illumination, it is possible to calculate averages of off-diagonal regions of the emissivity or transmissivity matrices. With measurements using monochromatic or near-monochromatic illumination in the fluorescent absorption bands, it is possible to calculate the individual off-diagonal elements of the matrices.

The presented solution makes it possible to calculate the individual off-diagonal elements of the radiance transfer factor matrix, whether in transmission or remission when using two or more different conditions of illumination that are not predetermined.

The basic idea of the present invention is (i) to use one or more optical power sources which are intrinsically variable or of low stability in spectral power distribution to illuminate the material, (ii) to divide the beam from the optical power source into two so that one beam is directed to reference measurement and another beam is directed to a measurement of the sample (the beams should have substantially equal relative spectral power distributions), (iii) to measure both the spectral power distribution of the reference beam and the spectral power distribution of the optical radiation reflected from and/or transmitted through the sample material, (iv) to derive the fluorescent and non-fluorescent contributions to optical properties, such as color, from a plurality of such measurements by means of a statistical decomposition of the variance in the measurements.

A plurality of measurements are made sequentially, each comprising measurement of the spectral power distribution of the reference beam and simultaneous measurement of the spectral power distribution of the optical radiation reflected from and/or transmitted through the sample. These spectral power distributions preferably substantially span the near-ultraviolet and visible ranges in a plurality of wavelength bands which are preferably substantially contiguous.

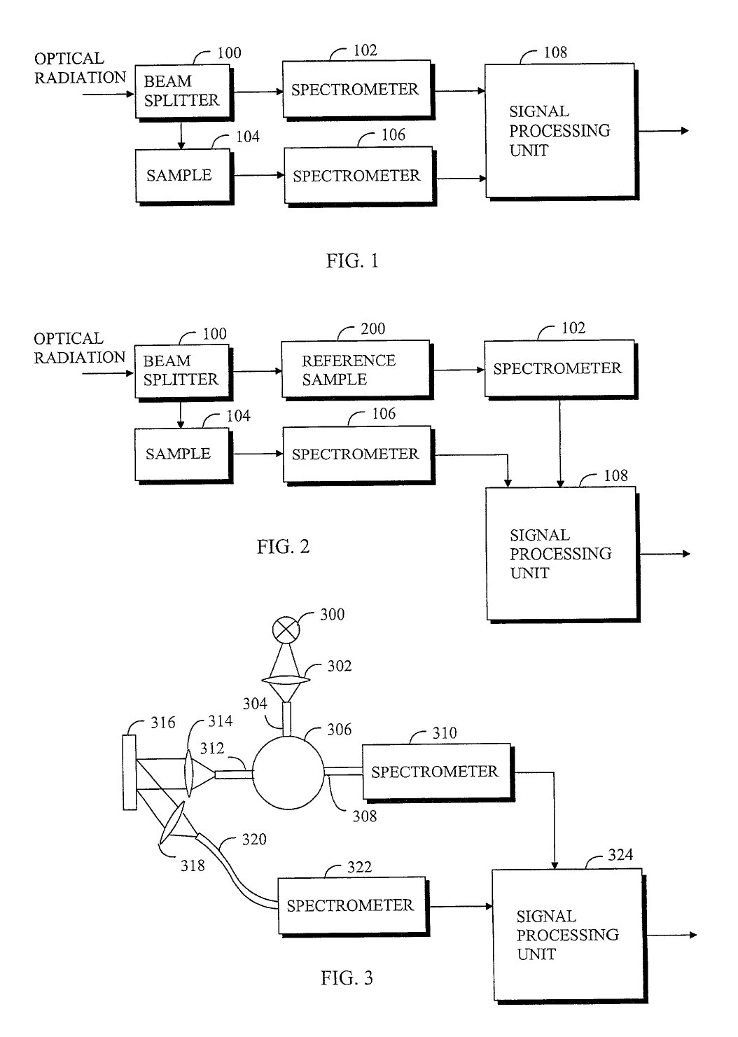

Let us now consider the presented solution in more detail with reference to FIG. 1. Optical radiation which is not monochromatic but covering a desired spectral band is directed at a beam splitter 100, which divides the optical radiation into two parts. Optical radiation refers in this application to electromagnetic radiation the wavelength of which is approximately between 100 nm and 2 μm. The power of the two parts of the divided optical radiation can be either the same or different, but the spectrum, which refers particularly to spectral power distribution, is the same in both. The part of the radiation directed from the beam splitter 100 directly at a spectrometer 102 is used as reference measurement, by means of which the spectrum of the optical radiation emitted from an optical power source is determined. Thus, the beam splitter 100 functions as a reference (particularly an integrating sphere can fulfil that function). The reference optical power is measured with a monochromator and array of detectors in the spectrometer 102, for example from 300 nm to 780 nm at 10 nm intervals. The detectors can be calibrated to be linear, with compensation for known nonlinearity or known zero point offset.

The other part of the optical radiation is directed onto a sample 104 to be measured, with which the optical radiation interacts. In the interaction, the optical radiation is reflected from the sample and transmitted through the sample, there being possibly changes in the spectral power distribution.

The measurement beam is directed onto the sample to be measured, using the same geometry as the reference beam. The remitted optical power from the sample is measured with a monochromator and array of detectors, for example from 380 nm to 780 nm at 10 nm intervals. The detectors must be calibrated to be linear, with compensation for known nonlinearity. Preferably, the combination of monochromator and detector used for measuring the reference beam and the combination of monochromator and detector used for measuring the sample beam are substantially identical, especially in wavelength range, wavelength interval, and slit functions.

The interaction of the optical radiation with the sample 104 changes the spectrum of the optical radiation in a manner that depends on the optical properties of the sample. In the presented solution the sample is preferably an intermediate product or a final product of processes used in the paper industry, such as pulp, paper or paperboard. The optical radiation from the sample 104 is directed towards a spectrometer 106, which measures the spectrum of the optical radiation that has interacted with the sample. In both the reference measurement and the measurement of the sample 104, it is particularly the spectral power distribution that is measured from the spectrum. A signal-processing unit 108, which can be a computer or other automatic data processing device compares several reference spectrums of the optical radiation with the spectrums of the optical radiation that has interacted with the measurement object and determines the desired optical property of the sample 104. A signal-processing unit 108 receives the reference spectrum of the optical radiation and the spectrum of the optical radiation that has interacted with the sample and the signal-processing unit 108 estimates a radiance transfer factor for transmission or remission based on the set of reference measurements and the set of sample measurements.

FIG. 2 shows a solution otherwise similar to that of FIG. 1 except for the reference measurement having such a difference that the spectrometer 102 measures the spectrum of the optical radiation having interacted with the reference sample 200. The reference beam is directed onto a non-fluorescent reference material of known spectral reflectance. The reference sample 200 can be a diffusely reflective material of known diffuse reflectance, preferably one which approximates an ideal diffuser over the wavelength range to be measured. For example, the material marketed as Spectralon produced by Labsphere Inc. of Sutton N.H. is suitable for the near ultraviolet and visible ranges. For those skilled in the field, the two spectrometers 102 and 106 can be replaced by an imaging type spectrometer or a dual-beam spectrometer utilizing a single array.

In the presented solution, at least one optical power source can be used, the spectral power distribution of which varies as a function of time. Alternatively, two optical power sources can be used, of which the spectral power distribution of the first one is as stable as possible as a function of time, and the spectral power distribution of the second one varies as a function of time. FIG. 3 shows a solution in which one lamp 300 functions as the source of optical radiation, the spectral power distribution of which lamp varies as a function of time. Most non-monochromatic optical power sources are intrinsically variable to some extent in their spectral power distributions. The lamp 300 can be a filament lamp or a gas-discharge lamp. By using an optical power source of low stability in spectral power distribution, such as a Xenon flash tube, the spectral power distribution of the optical radiation used to illuminate the sample varies over a range of distributions. In practice, for many types of flash tube the range of variation is quite broad, and the pattern of variation is nearly random. Thus, the condition of illumination of the sample is different in each flash. Instead of a flashing optical power source, other means of illumination could be used, provided they exhibit a variation in their spectral power distribution from time to time.

Instability of the optical power source is a virtue rather than an impediment in this invention, with the benefit that a less expensive optical power source can be used. Moreover, the number of optical components is reduced, since in many cases only one optical power source is required, with no moveable filters or arrangements for stabilizing optical power sources, or arrangements for approximating particular standard illuminants.

Optical radiation of the lamp 300 is collected by means of an optical component 302 into a light pipe 304, which can be an optical fibre or a fibre bundle, for instance. The optical radiation advances along the light pipe 304 to the beam splitter 306, which is preferably a metal sphere whose inner surface is coated with a diffusely reflecting substance of high diffuse reflectance, such as randomly oriented microcrystalline Barium Sulphate. Preferably, the openings for light pipes to convey light to and from the sphere are not situated diametrically opposite one another, and the direct light path to or from a light pipe preferably follows a radius of the sphere. Preferably, gloss traps of low reflectivity are situated diametrically opposite each light pipe opening, and openings for light pipes are separated from gloss traps and from other openings by a distance at least equal to their own diameter. Preferably, the openings and gloss traps in combination occupy less than 10% of the interior surface area of the sphere. The inner surface of such an integrating sphere effectively reflects and mixes the optical radiation coming from the light pipe 304. With a near-ideal beam splitter, such as the spherical device, the measuring beam and reference beam have substantially equal relative power distributions, although their absolute powers need not be equal, and their relative total radiant powers will be substantially determined by the relative areas of the openings for their respective light pipes from the sphere. Thus, it is possible to effectively measure the relative power distribution of the beam used to illuminate the material whose optical property is to be measured.

In the simplest case, a thin sheet of glass can be used as the beam splitter instead of a sphere. Hereby, the optical radiation measuring the sample is transmitted through the glass, and the reference can be measured from the reflected radiation. Also two right-angle prisms cemented together at their hypotenuse faces can be used as the beam splitter. Prior to the cementation, the hypotenuse surface of one prism is coated with metal or a dielectric material. In this way, the radiation on the common surface of the prisms is divided to a desired extent into a reflected beam and a transmitted beam. When something other than a sphere is used as the beam splitter 304, a lens or arrangement of optical elements such as lenses or mirrors which collect optical power can be used between light pipes 304, 308 and 312 and the beam splitter 304 to decrease the loss in optical power, although lenses are not required when using a sphere. From the beam splitter 306 the optical radiation advances along the light pipe 308 to the reference measurement in a spectrometer 310, which forms a spectral power distribution of the optical radiation.

From the sphere 306 the optical radiation advances through the light pipe 312 towards the measurement of the sample. The radiation from the end of the light pipe 312 is collimated or focused by means of an optical component 314 on a sample 316. The optical radiation that has been reflected from the sample (or that has advanced through the sample) is collected by means of an optical component 318 into a light pipe 320, which transfers the optical radiation to a spectrometer 322 to form a spectrum. A signal-processing unit 324 compares the reference spectrum with the spectrum received from the sample.

For optical measurements which require diffuse illumination of the sample, the collimation component 314 is not required. In these cases, a sphere with an opening substantially in contact with the sample may be used to diffusely illuminate the sample, light being conveyed to the sphere by light pipe 312 through another opening, and light remitted from the sample being conveyed to the detector along light pipe 320 from another opening in the sphere. The opening for light pipe 320 is preferably diametrically opposite the opening for the sample, while the opening for light pipe 312 is preferably diametrically opposite a gloss trap.

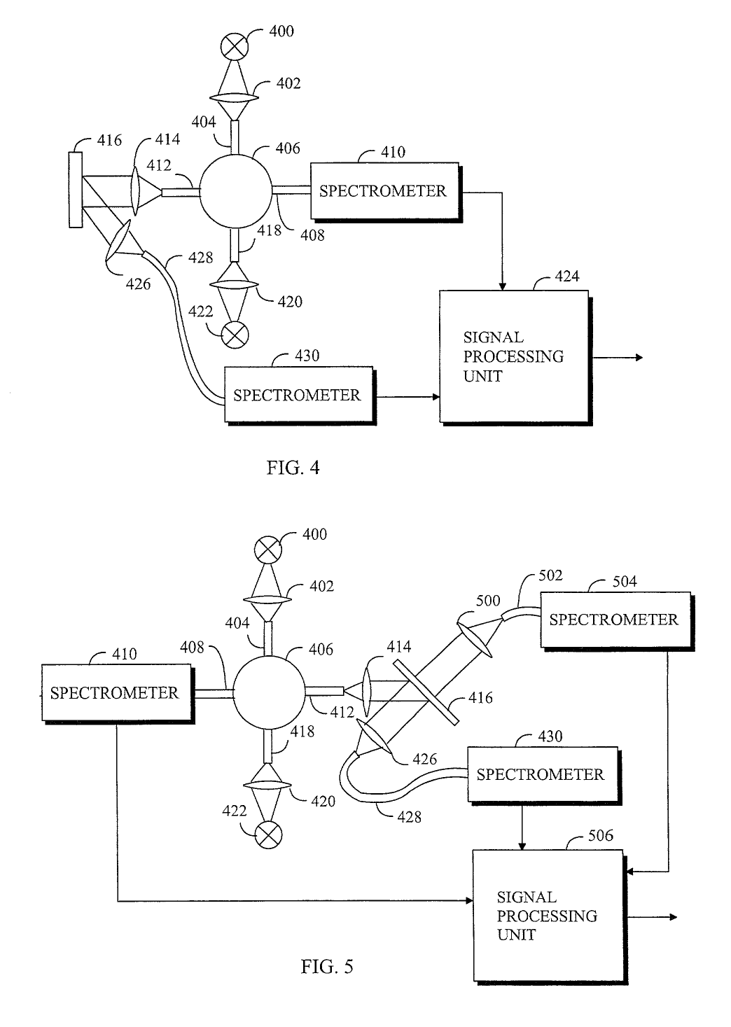

The solution of FIG. 4 is otherwise similar to that of FIG. 3 but the illuminator is a combination of two physical sources. The range of variation in illuminator spectral power distribution increases by illuminating with beams of optical radiation from a plurality of optical power sources separately or in combination. Preferably, at least one optical power source is intrinsically variable or of low stability, and not all optical power sources exhibit a similar spectral nature in their variability. Alternatively, two or more optical sources which are of stable spectral power distribution can be used, provided the total power to at least one is varied, so that the spectral power of their combined light is affine. Affine optical power P can be expressed as an affine polynomial P=P₀+P₁·r₁, where P₀ and P₁ are known optical powers, and r₁ is a variable, whose value is known to be within a positive range [a . . . b], where both a and b are nonnegative, and represent the range of total power of the source whose power is varied. The uncertain variable r₁ represents the variability in the optical power P. Optical power P₀ is the power below which the optical power never falls, and P₁·r₁ represents the optical power which varies. If the total power of two spectrally stable optical sources is varied, then the affine power is P=P₀+P₁·r₁+P₂·r₂ or, if there is no source of constant power, P=P₁·r₁+P₂·r₂.

From a first optical power source 400, which is stable, optical power is collected by means of an optical component 402 into a light pipe 404, along which the optical radiation advances to a Beam splitter 406. The lamp 400 can be filtered so as to approximate the relative spectral power distribution of a particular illuminant with varying total power. The particular illuminant can be a CIE standard illuminant C or, CIE D-series (D₆₅, etc), CIE F-series etc. Correspondingly, from a second optical power source 422, which is of low stability, optical power is collected by means of an optical component 420 into a light pipe 418, along which the radiation advances to the beam splitter 406, which is an integrating sphere to combine the radiation from a plurality of sources. An integrating sphere can be used to combine beams from a plurality of optical power sources in a near-ideal way. The combined optical beams can be split into a plurality of beams of substantially equal spectral power distribution in the device which combined the beams, or in a separate device to which the combined beam is conveyed. The radiances from both optical power sources are thus combined using a high-efficiency integrating sphere 406, and divided into two beams of substantially identical spectral power distribution. The beams need not be of the same total radiant power, and their relative total radiant powers will be substantially determined by the relative areas of the openings for their respective light pipes from the sphere. From a beam splitter 406 the optical radiation advances along a light pipe 408 to the reference measurement in a spectrometer 410. In the same way, the optical radiation advances from the beam splitter 406 along the light pipe 412 to the end of the light pipe 412, from where the optical radiation is directed by means of an optical component 414 onto a sample 416. The optical radiation reflected from or transmitted through the sample 416 is collected by means of an optical component 426 into a light pipe 428, along which the optical radiation advances to the spectrometer 430. The signal-processing unit 432 compares several spectrums measured from the sample 416 with the corresponding reference spectrums and determines the desired optical property from the sample 416.

The first optical power source 400 is as stable as possible with regard to the spectral power distribution, in particular. The first optical power source 400 approximates for example CIE standard illuminant C, with fixed power. The second optical power source 422 is such that its spectral power distribution varies as a function of time. The second optical power source 422 approximates for example CIE standard illuminant D₇₅, with power varying randomly from 0 to 50% of the power of the primary source. The optical power sources can function in a continuous or chopped manner. In chopped function, the optical power sources are stroboscopic optical power sources that are electronic flash tubes capable of generating up to thousands of flashes per second.

FIG. 5 shows a solution otherwise similar to that of FIG. 4, except that in this solution both reflected optical radiation and transmitted optical radiation are measured from the sample 416. Optical radiation is directed onto the sample by means of an optical component 414, and reflected optical radiation is collected by means of an optical component 426 into a light pipe 428, along which the optical radiation advances to the spectrometer 430 for measurement. In a corresponding way, optical radiation transmitted through the sample 416 is collected by means of an optical component 500 into a light pipe 502, along which the optical radiation advances to a spectrometer 504 for measurement. The results measured by means of the spectrometer 410, 530 and 504 are transferred to a signal-processing unit 506, which determines the desired optical properties of the sample 416. In FIGS. 1 to 5, the optical component 302, 402, 420, 426 and 500 is a lens or a combination of lenses.

In the solutions shown in FIGS. 1 to 5, one or more optical power sources make for example 100 flashes on each sample (equivalent to 2 second measurement at 50 Hz flash rate). For each flash, the spectral power distribution is measured using the reference spectrometer. The optical power that has interacted with the sample is measured with measurement spectrometer. Detectors in both spectrometers introduce some noise into their measurements. The spectral power distribution of the flash varies randomly or in a controlled manner.

Random variation of the spectral power distribution as a function of time takes place naturally in an optical power source of low stability, inexpensive electric lamps being often such sources. In order to change the spectral power distribution, the power supply of optical power sources can also be changed, whereby also the spectral power distribution changes. Thus, for instance, changing the operating voltage of the optical power source changes the spectral response. The power supply can be changed randomly or deterministically. The spectral power distribution can be changed in a controlled manner deterministically, whereby the power supply is changed in accordance with a predetermined sequence. The sequence can be systematic, for example in such a way that the power supply is increased gradually from low power to higher power (or decreased from high power to lower power), or pseudo-random, whereby the power supply is changed apparently randomly.

In the solutions according to FIGS. 1 to 5, the signal-processing unit 108, 324, 432, 506 determines the desired optical property from the sample, such as a radiance transfer factor B, for transmission or remission of radiance from the sample. These properties enable for instance determination of the color of the sample under arbitrary conditions of illumination. According to the presented method reference measurements are performed by measuring the spectrum of the optical band illuminating the sample at separate instants of time. Then a spectrum of a band of the optical radiation that has interacted with the sample at the corresponding separate instants of time is measured. Instead of averaging these measurements together to obtain a mean measurement as in prior art solutions, the differences and variability (largely caused by variability in illumination) of the spectral power distribution in the measurements is exploited. In essence, the radiance transfer factor B for remission from and/or transmission through the sample is calculated using a multivariate statistical decomposition of the variance in the measurements and the variance in the illumination. The methods are explained below for estimation of radiance transfer factor B for remission from the sample, using measurements of remitted light, but the radiance transfer factor for transmission can be estimated in exactly analogous fashion, using measurements of transmitted light.

The measured spectral power distribution of the optical power source at each measurement instant is stored as a column of matrix S representing the set of illumination conditions. The measured spectral power distributions of optical radiation remitted (reflected or fluoresced) from the sample at each measurement instant are stored in corresponding columns of matrix R. The columns of R correspond to those of S. When using stroboscopic optical power sources the measurement instant is the instant when the optical power source flashes. We assume for clarity of explanation, and without loss of generality, that the wavelength intervals are identical, and are equal to unity, so that from (1):

R=BS (9)

Clearly, if there are sufficient columns in R and S (i.e., sufficient measurements), then this relation can be inverted:

B=RS⁻¹ (10)

Note that in many cases, the calculation (10) need not be performed for the whole matrix B. This is because the fluorescent excitation-emission relations are commonly confined to some subset of the measured wavelength range, and the matrix B is therefore known to be diagonal outside that subset of wavelengths and to have significant off-diagonal elements only within the subset. Thus, if the wavelength ranges for fluorescent excitation and emission are approximately known a priori, the inversion need only consider the relevant block of data, and a simpler estimation method can be used for the diagonal elements corresponding to other wavelengths.

In practice, the measurements will contain some amount of noise due to imperfect components such as monochromators or optical detectors, and so forth. Thus, in order to measure fluorescence the number of different illumination states must exceed the number of measured wavelength bands in the excitation region (or rows in the matrices) for which the absorption-emission relationship is to be estimated. Illumination states can differ from each other by spectral power distributions and/or by the total optical power in the optical band of interest in the measurement illuminating the sample. A least-squares inverse can be obtained which minimizes the effect of noise:

B=RS^{T}(SS^{T})⁻¹ (11)

Just as for equation (10), not all wavelength bands need be used in equation (11). In the presence of large amounts of detector noise, the unconstrained least-squares approach in (11) can yield some physically impossible values: (i) fluorescence from long wavelengths to short wavelengths, (ii) negative radiance transfer factors. However, the erroneous values are obvious and easily corrected (by setting to zero). They also tend to be rather small in magnitude, and occur only where the true radiance transfer factors are zero or negligibly small. However, a constrained least-squares estimation can be used instead of the unconstrained method, thus avoiding these potential problems. In this case, the estimation is constrained such that the radiance transfer factor B is a triangular matrix, and all elements of B are non-negative. Although a constrained estimation is computationally more demanding than the unconstrained estimation, the number of elements to be estimated in a triangular matrix is reduced almost by half compared to the unconstrained matrix.

By measuring the radiance transfer factor for remission and/or transmission, the corresponding total radiance factor can be reliably calculated for the sample for illumination with a light source of arbitrary spectral power distribution. In prior art devices, this was possible only by employing monochromatic illumination at each wavelength interval in the fluorescent excitation band.

By employing multivariate decomposition of variance instead of averaging, the emissivity and/or transmissivity matrices can be measured using a device of low complexity and without requiring use of monochromatic optical power sources.

The mathematical details are not the essence of the invention, but what is important is that the use of variable illumination conditions and the analysis of the consequent variation in measurements enables determination of the radiance transfer factor, and hence enables calculation of the total radiance factor under arbitrary conditions of illumination.

Often only wavelength bands which are within either the absorption or the emission band of a fluorescent relation need be included in the matrices. For other wavelength bands, the radiance transfer factor B is diagonal. For example, if the spectral power distribution measurements are obtained in 40 bands each of 10 nm covering the range from 300 nm to 700 nm, but fluorescent absorption is known to occur only from 300 nm to 410 nm and the corresponding fluorescent emission is known to occur only from 390 nm to 500 nm, then the bands from 500 nm to 700 nm need not be considered in (10) or (11), and the matrices need to have only 20 rows. Thus, an estimate of B by exact inverse (10) can be calculated with 20 flash measurements, while a least-squares estimate (11) can be calculated using more than 20 flash measurements.

In most cases, the effect of fluorescent emission appears in a single region of B, and the dominant matrix elements in that region are approximately Grammian. This is described in more detail in Shakespeare, T., Shakespeare, J., “Problems in Colour Measurement of Fluorescent Paper Grades”, Analytica Chimica Acta, 380(1-2) 227-242, January-February 1999, which is incorporated as reference herein. This means that the number of independent values to be estimated is much less than the number of elements of B which they determine. Thus, an acceptable approximation of B can be represented as:

$$B = diag ( B ) + {\sum }_{i = 1}^{N} {u}_{i} {v}_{i}^{T} \qquad ( 12 )$$

where uᵢ and vᵢ are column vectors which respectively describe the absorption and emission spectra of fluorescence relation i, and N is the number of column vectors concerned, and their Grammian product uv^{T} is a matrix. Note that different column vectors need not be non-overlapping.

The following simple example illustrates the properties of B. First, all elements below the diagonal are zero, since it is physically impossible to emit radiance at a shorter wavelength to the absorbed excitation radiance. Second, the off-diagonal elements are concentrated in the upper half of the matrix, so that the last three rows constitute a diagonal matrix since there is no fluorescent excitation at those wavelengths.

$$B = [ \begin{matrix}0.7 & 0.01 & 0.02 & 0.04 & 0.07 & 0.03 \\ 0 & 0.5 & 0.02 & 0.12 & 0.21 & 0.09 \\ 0 & 0 & 0.6 & 0.08 & 0.14 & 0.06 \\ 0 & 0 & 0 & 1 & 0 & 0 \\ 0 & 0 & 0 & 0 & 1 & 0 \\ 0 & 0 & 0 & 0 & 0 & 1\end{matrix} ]$$

Thirdly, the off-diagonal elements are dominated by the block where the emission wavelengths do not overlap the excitation wavelengths, namely the rightmost three columns of the top three rows. This dominant block can be closely approximated by a single Grammian product, since the emission spectrum for each excitation wavelength is similar, except where the excitation and emmission bands overlap.

$$[ \begin{matrix}0.04 & 0.07 & 0.03 \\ 0.12 & 0.21 & 0.09 \\ 0.08 & 0.14 & 0.06\end{matrix} ] = [ \begin{matrix}0.2 \\ 0.6 \\ 0.4\end{matrix} ] [ 0.2 \; 0.35 \; 0.15 ]$$

This decomposition is not unique, and can be expressed equivalently in other ways. The important point is that nine off-diagonal elements of the matrix B can be adequately quantifed using only six values with an expansion (12) in which N=1. In practice, the reduction of dimensionality is greater than in this example, as the emission region of B can contain hundreds of elements for a single fluorescent emission, yet be adequately quantified by a few dozen values in a Grammian product. For a large emission region, it is advantageous to use an expansion (12) with more than one term in the Grammian series. This kind of reduction in dimensionality can be exploited to obtain a more robust and more reliable least-squares estimation.

Suitable methods for estimating a parametrization such as (5) include partial least-squares regression, principal components regression, ridge regression, continuum regression, canonical correlation analysis, and numerous variations and related methods. These and other suitable variance decomposition methods are described in Basilevsky, A., Statistical Factor Analysis and Related Methods, Wiley, New York N.Y., 1994, for example.

Since the spectral power distribution of the optical power source varies over a range of distributions, the fluorescence in the material is excited to differing extents in each flash. The greater the range of variation and the more random the pattern of variation in illumination, the better the presented method will work.

The presented solution can be used for characterizing the optical properties of a material in a way which is independent of the illumination, and hence determining the color of a material under arbitrary conditions of illumination, especially when the material is fluorescent. The remitted or transmitted color of a fluorescent material is determined by its total radiance factor for remission or transmission (i.e. its apparent reflectance or apparent transmittance), which in turn depends on the spectral power distribution of the illumination and the radiance transfer factor for remission or transmission, which is independent of illumination. Color is conventionally expressed as calorimetric quantities having three values. Colorimetric coordinate systems in common use include for example CIE Tristimulus; CIE Chromaticity; Lightness; CIELAB; CIELUV; Hunter Lab; OSA Ljg system; Hue Angle, Saturation Value and Dominant wavelength, Excitation purity etc.

The tristimulus values are calculated from the reflectance factor or transmittance factor of an object, using the spectral power distribution of the illuminant for which the object's color appearance is to be evaluated. Conventionally, tristimulus values are defined as integrals but are normally evaluated as finite approximations:

$$\begin{matrix}X = k {\int }_{380}^{780} R ( λ ) IS ( λ ) \overline{x} ( λ ) ⅆ λ = k {\sum }_{j = 1}^{N} {R}_{j} {IS}_{j} {\overline{x}}_{j} δλ \\ Y = k {\int }_{380}^{780} R ( λ ) IS ( λ ) \overline{y} ( λ ) ⅆ λ = k {\sum }_{j = 1}^{N} {R}_{j} {IS}_{j} {\overline{y}}_{j} δλ \\ Z = k {\int }_{380}^{780} R ( λ ) IS ( λ ) \overline{z} ( λ ) ⅆ λ = k {\sum }_{j = 1}^{N} {R}_{j} {IS}_{j} {\overline{z}}_{j} δλ\end{matrix} \qquad ( 15 )$$

where k is a normalization factor, IS is the spectral power distribution of the target illuminant, \overline{x}, \overline{y}, \overline{z}, are the standard observer functions, tabulated at uniform wavelength intervals and R(λ) is the true reflectance (or transmittance). These relations assume that either (i) fluorescence is absent or negligible, so that the apparent reflectance is identical to the true reflectance, i.e. β(λ,λ)=R(λ), and β(ζ,λ)=0 if ζ≠λ or (ii) R(λ) was measured using exactly IS(λ) as the illuminator in the measuring instrument, so that the measured apparent reflectance is valid for the target illuminant.

Hunter L,a,b is used widely in the papermaking industry in the USA, but rarely elsewhere, as CIELAB is preferred in the papermaking industry in most other regions, and is also used in the USA. The CIELAB values are defined for photopic conditions as follows:

$$\begin{matrix}{L}^{*} = 116 {( Y / {Y}_{n} )}^{1 / 3} - 16 & ( 16 ) \\ {a}^{*} = 500 [ {( X / {X}_{n} )}^{1 / 3} - {( Y / {Y}_{n} )}^{1 / 3} ] & ( 17 ) \\ {b}^{*} = 200 [ {( Y / {Y}_{n} )}^{1 / 3} - {( Z / {Z}_{n} )}^{1 / 3} ] & ( 18 )\end{matrix}$$

where Xₙ, Yₙ, and Zₙ are the tristimulus values for the illuminant. Photopic conditions exist when the ratios X/Xₙ, Y/Yₙ, and Z/Zₙ all exceed 0.008856; otherwise either mesopic or scotopic conditions exist, and the equations used differ from (13), (14) and (15), as described in ASTM test method E308-90, for example. These and other issues of colorimetry are well known per se. Color has been discussed in greater detail for example in Berns, R. S., “A generic approach to color modeling” in “Color research and application”, Vol 22, number 5, 1997, to be included herein as a reference.

The brightness of the sample can be estimated from the spectral radiance transfer factor. The brightness can be expressed in a standard brightness scale. Standard brightness scales include ASTM blue reflectance, TAPPI brightness, ISO brightness, D₆₅ brightness, etc. as well as parametrized correlates of perceptual brightness B=aL^{c}−B₀ for various values of parameters a, c and B₀.

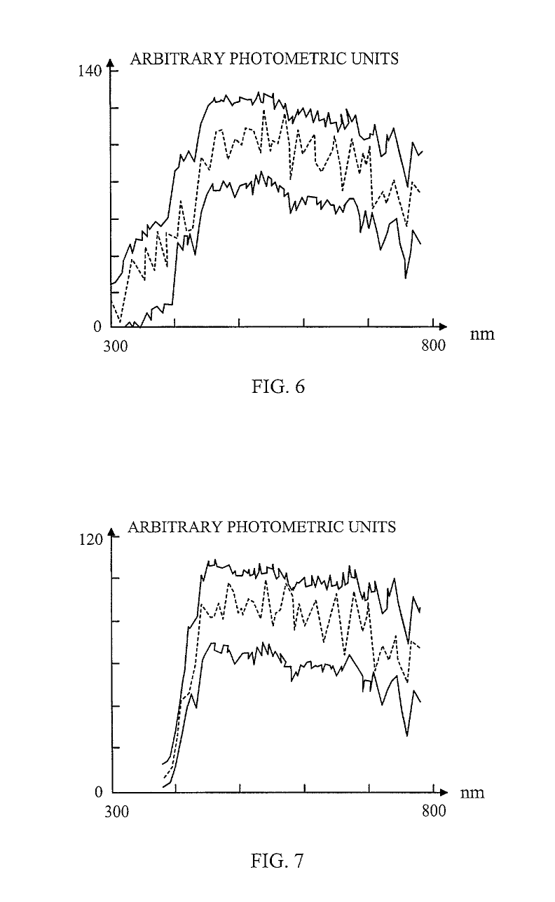

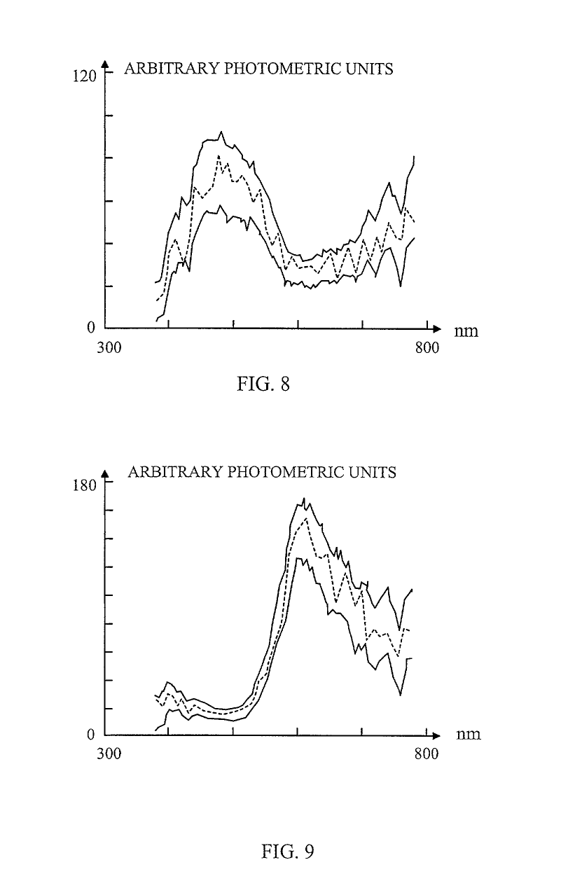

FIGS. 6 to 9 show spectral power distributions at a scale in which the power is indicated on the vertical axis and the wavelength on the horizontal axis. FIG. 6 shows the spectral power distribution of a hundred different flashes of an unstable power source measured by the spectrometer. The total power over the spectrum has changed to some degree, but the curves show that the spectral power distribution is clearly different at different flashing times. The responses to the flashes from different samples are presented in FIGS. 7 to 9. FIG. 7 illustrates the spectral power distribution of a hundred different flashes of the optical radiation reflected from a fluorescent white sheet. FIG. 8 shows the spectral power distribution of a hundred different flashes of the optical radiation reflected from a non-fluorescent blue sheet. FIG. 9 shows the spectral power distribution of a hundred different flashes of the optical radiation reflected from a fluorescent orange sheet.

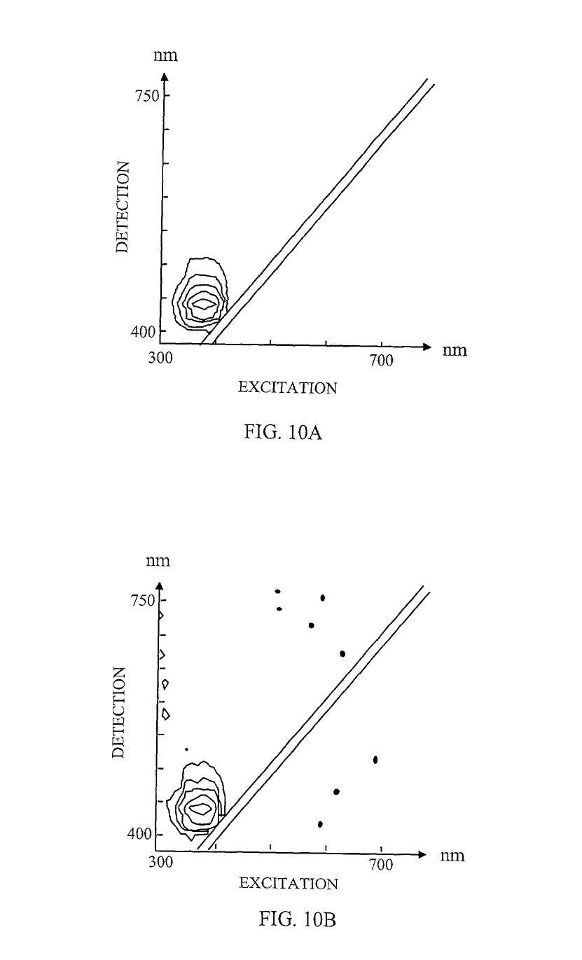

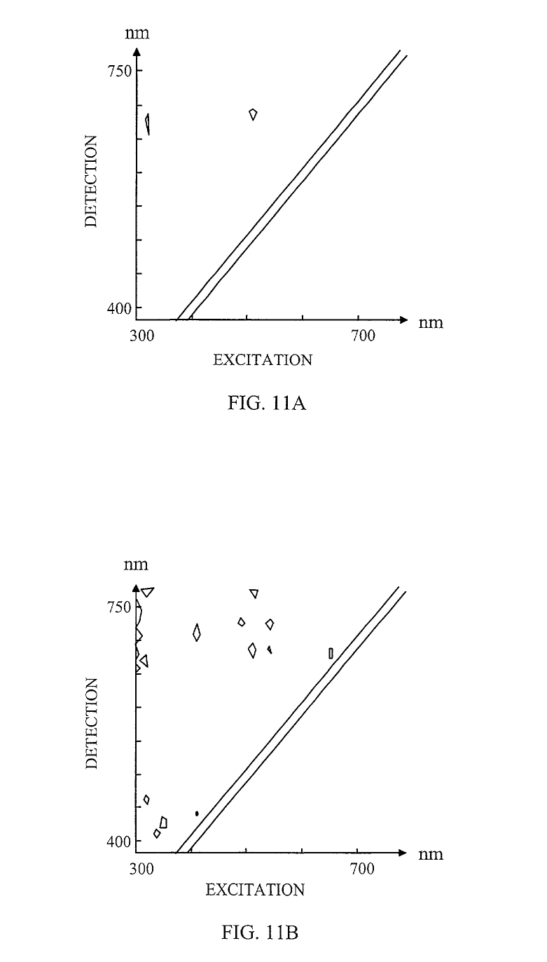

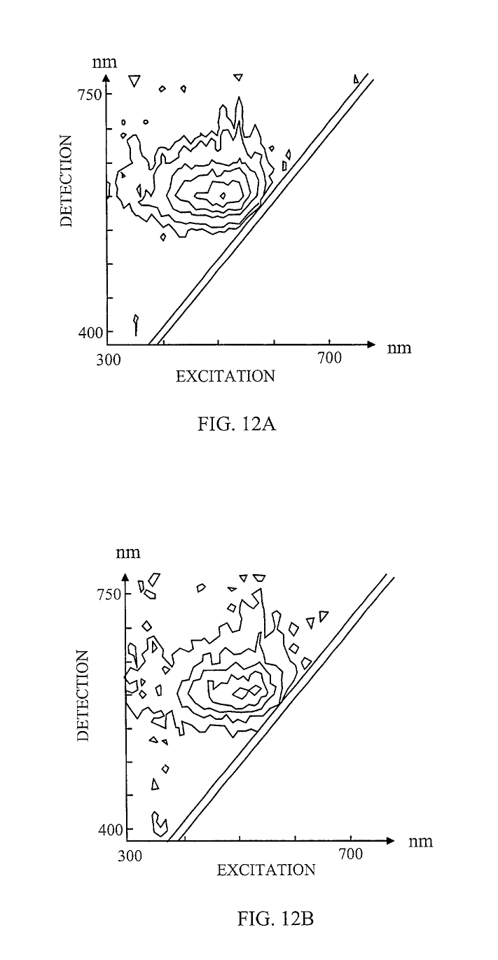

FIGS. 10A to 12B illustrates results of a simulated gauge designed to give results compatible with a particular dual-monochromator instrument, in this case the BFC-450 marketed by Labsphere Inc. of Sutton N.H. The reference is measured from 300 nm to 780 nm, while the sample is measured from 380 nm to 780 nm. Simulations of the proposed instrument were carried out using Matlab program. A real gauge based on the presented solution would preferably be designed with equal spectral ranges for reference and sample detectors. The most useful range is from approximately 320 nm to at least 720 nm. As results of the simulation, FIGS. 10A to 12B show contour plots of the radiance transfer factor measured with a real BFC-450 instrument and of the radiance transfer factor B estimated in accordance with the presented solution for the samples of FIGS. 7 to 9, which are illuminated with flashes according to FIG. 6. The vertical axis represents the wavelength of optical radiance emitted radiation measured from the sample, and the horizontal axis represents the wavelength of optical radiance for excitation radiation originating from an optical power source. FIG. 10A shows the radiance transfer factor of a fluorescent white sheet as measured with the BFC-450, and FIG. 10B shows an estimated radiance transfer factor. FIG. 11A shows the radiance transfer factor of a non-fluorescent blue sheet as measured with the BFC-450, and FIG. 11B shows an estimated radiance transfer factor. FIG. 12A shows the radiance transfer factor of a fluorescent orange sheet as measured with the BFC-450, and FIG. 12B shows an estimated radiance transfer factor. As a summary of FIGS. 10A to 12B it can be noted that in accordance with the presented solution the estimated radiance transfer factor is very similar to the real radiance transfer factor. Very low grade detectors were used for this simulation, with a simulated noise level of 0.5% of full scale. With better accuracy in the detectors, the estimation is greatly improved. For a noise level in each detector of 0.1% of full scale, the estimated values are essentially identical to the values measured by the BFC-450, which is a much more complex dual-monochromator instrument with detectors of very high accuracy.

The presented solution can be applied for measuring a property in the cross-machine direction of a moving web. For example, a measuring device constructed according to the presented solution may be mounted on a platform which traverses the moving paper web. Alternatively, a plurality of such devices may be deployed in particular locations across the moving web, or a plurality of such devices may each traverse a portion of the width of the web. Additionally or alternatively, light pipes or other means may be employed to direct optical beams from at least one optical power source to each of plural locations across the moving web, and from each of plural locations across the web to at least one optical detector. These solutions are described in more detail for example in U.S. Pat. Nos. 4,565,444 and 4,801,809, which are incorporated as reference herein.

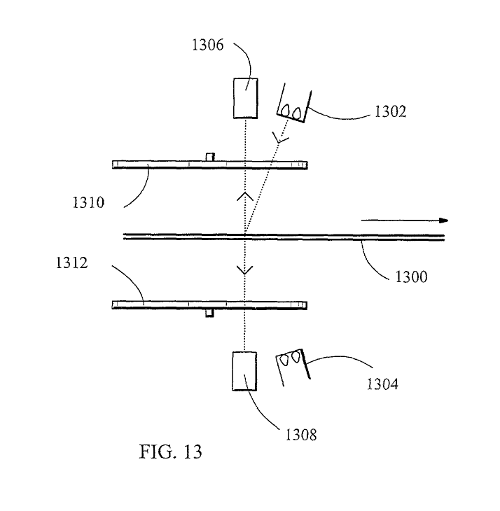

The presented solution can be applied to measuring the two-sided color of a material as shown in FIG. 13. The arrangement of devices can advantageously be according to the solution disclosed in U.S. Pat. No. 5,991,046 for example, in which optical power sources 1302 and 1304 and optical detectors 1306 and 1308 can be situated on both sides of a moving web 1300, opposite to each other. The measurement is performed through calibration units 1310 and 1312 that comprise operating elements for various measurements. Operating elements can be such as a hole, a non-glossy non-fluorescent reference of known high diffuse reflectivity for white level calibration, a black reference such as a cavity or other light trap, a non-glossy non-fluorescent black tile of known low diffuse reflectivity, a non-glossy, non-fluorescent translucent reference of known diffuse transmittance for transmittance measurement, a non-scattering translucent reference of known directional transmittance, a specular element of known specular reflectivity, a glossy non-fluorescent reference of known gloss factors, or a non-glossy fluorescent reference of known fluorescence factors and known diffuse reflectance. Thus, both reflected and transmitted optical radiation are measured in each state of illumination, and color determined from both sides, and the scattering, absorption, and fluorescence properties of the sheet determined therefrom.

The presented solution can be applied for measuring the color of a material according to various geometries. CIE recommends four illuminating and viewing conditions to be used for diffusely reflecting non-fluorescent samples: 45°/normal (45/0), normal/45° (0/45), diffuse/normal (d/0) and normal/diffuse (0/d). Color can be measured also according to particular implementations of these geometries, or variant geometries, such as 45/0 unidirectional, 45/0 annular, d/8, etc. For measurements of fluorescent samples 45/0 or 0/45 conditions usually are, however, required to minimize sample-instrument interaction. Other geometries may be preferable in particular circumstances, for instance if the specimen exhibits significant specular reflectivity or directional variation in reflectivity. The presented solution can also be used for measuring according to a plurality of geometries simultaneously or sequentially.

The presented solution can be used in characterizing the effect on the color of a material during manufacture caused by changing the composition or processing conditions of the material. For example, the color of a sample manufactured in a first process state can be measured according to the present invention, the manufacturing process can then be modified to a second state, and then the consequent color of a sample manufactured in the second process state can be measured according to the present invention. The change in the process state can be for example a known change in the combinatory proportions of one or more feed streams in the process, or a known change in the operating parameters such as temperature or pressure of the manufacturing equipment. The difference in color of the material between the two process states can be parametrized in terms of the change in the process state using an ad hoc correlation model, or by fitting to an a priori model such as a physical model. In particular, a model can relate changes in the radiance transfer factor of the material determined according to the present invention to the change in process state. Alternatively, a model can relate changes in the absorption, scattering, and fluorescence of the material determined according to the present invention to the change in process state. Alternatively, a model can relate changes in the apparent reflectance or apparent transmittance determined according to the present invention for one or more conditions of illumination to the change in process state

The presented solution can be applied for controlling the color of a material during manufacture. For example, flows of fluorescent or non-fluorescent dyes or pigments may be governed to minimize the difference between the measured color and the desired color, which is described in more detail in Shakespeare, J., Shakespeare, T., “An Optimizing Color Controller”, Proc. TAPPI PCE&I '97 (Birmingham Ala., Mar. 10-13, 1997), p.127-135, which is incorporated as reference herein. By determining the color of the sample using both fluorescent and non-fluorescent phenomenon, which can be estimated by means of the presented solution, the control of the color can be intensified. The desired color may be provided for one or more conditions of illumination, and the control may minimize illuminator metamerism for the specified conditions of illumination. Such a solution, in turn, is described in greater detail in Shakespeare, T., Shakespeare, J., ‘Advanced Colour Control Through Reflectance Optimization’, Proc. 2^{nd} EcoPaperTech (Helsinki Finland, Jun. 1-5, 1998), p.183-194, which is incorporated as reference herein. Taking into account the optical property of both the fluorescent and non-fluorescent phenomenon in connection with the determination of color allows intensification of the control of the color.

Although the invention has been described above with reference to the example according to the attached drawings, it is obvious that the invention is not limited thereto but may be modified in a plurality of ways within the inventive idea defined in the attached claims.

What is claimed is:

1. A method for performing an optical measurement comprising:
illuminating a sample by a band of optical radiation the illumination state of which is variable as a function of time;
performing reference measurements by measuring the spectrum of the optical band illuminating the sample at least at three separate instants of time;
measuring a spectrum of a band of the optical radiation that has interacted with the sample at the corresponding separate instants of time as the reference measurement; and
estimating the radiance transfer factor matrix of the sample from the set of reference measurements and the set of sample measurements.

2. A method according to claim 1, wherein the measurement of the spectrum of the band of radiation which has interacted with the sample is made on the same side of the sample as the illumination, so that the estimated radiance transfer factor matrix is the emissivity matrix.

3. A method according to claim 1, wherein the measurement of the spectrum of the band of radiation which has interacted with the sample is made on the opposite side of the sample as the illumination, so that the estimated radiance transfer factor matrix is the transmissivity matrix.

4. A method according to claim 1, wherein the illumination of the sample or the measurement of the spectrum of the band of radiation which has interacted with the sample employs a diffuse geometry.

5. A method according to claim 1, wherein either the illumination of the sample or the measurement of the spectrum of the band of radiation which has interacted with the sample employs a directional geometry.

6. A method according to claim 1, wherein the variable in the illumination state is spectral power distribution.

7. A method according to claim 1, wherein the variable in the illumination state is the total power in the band of the optical radiation illuminating the sample.

8. A method according to claim 1, wherein the apparent reflectance of the sample is estimated from the radiance transfer factor for at least one known state of illumination.

9. A method according to claim 1, wherein the apparent reflectance of the sample is estimated for at least two different conditions of illumination, and its illuminator metamerism is evaluated with respect to a reference sample of known apparent reflectance in the same conditions of illumination.

10. A method according to claim 1, wherein the color of the sample is estimated from the radiance transfer factor for at least one state of illumination corresponding to a standard illuminant, and expressed in a calorimetric coordinate system.

11. A method according to claim 1, wherein the brightness of the sample is estimated from the radiance transfer factor for at least one known state of illumination, and expressed in a standard brightness scale.

12. A method according to claim 1, wherein the radiance transfer factor of both the fluorescent and non-fluorescent phenomenon are estimated.

13. A method according to claim 1, wherein the spectrum of the optical radiation is continuous in the optical band.

14. A method according to claim 1, wherein the illumination state is a random variable.

15. A method according to claim 1, wherein the variation of the illumination state is controlled deterministically.

16. A method according to claim 1, wherein the estimation of the radiance transfer factor matrix is performed using a least-squares estimation or constrained least-squares estimation.

17. A method according to claim 1, wherein elements of the estimated radiance transfer factor matrix which are negative or which correspond to physically impossible transitions are set to zero.

18. A method according to claim 1, wherein the least-squares estimate of the radiance transfer factor matrix B is formed by the matrix computation
B=RS^{T}(SS^{T})⁻¹
where R is the measured spectral power distribution of the sample beam in each of three instants and S is the measured spectral power distribution of the reference beam at the same instants, and B is the radiance transfer factor matrix.

19. A method according to claim 1, wherein the least-squares estimate of the radiance transfer factor matrix B is in the form:
$$B = diag ( B ) + {\sum }_{i = 1}^{N} {u}_{i} {v}_{i}^{T}$$
where uᵢ and vᵢ are column vectors which respectively describe the excitation and emission spectra of fluorescence relation i, and N is the number of fluorescent relations.

20. A method according to claim 13, wherein the least-squares estimate of the radiance transfer factor matrix B is formed by partial least-squares regression or by principal components regression or by canonical correlation analysis.

21. A method according to claim 1, wherein the reference measurements of the spectrum are performed at least partially in a different optical band than the measurements of the spectrum of the sample.

22. Apparatus for performing an optical measurement comprising:
at least one optical power source for illuminating a sample by a band of optical radiation the spectral illumination state of which is variable as a function of time;
means for measuring the spectrum of the optical band illuminating the sample at least at two separate instants of time as a reference measurement;
means for measuring a spectrum of a band of the optical radiation that has interacted with the sample at the corresponding separate instants of time as the reference measurement; and
means for estimating the radiance transfer factor matrix of the sample from the set of reference measurements and the set of sample measurements.

23. An apparatus according to claim 22, wherein the means for measuring the spectrum of the band of radiation which has interacted with the sample is on the same side of the sample as the at least one optical power source, so that the estimated radiance transfer factor matrix is the emissivity matrix.

24. An apparatus according to claim 22, wherein the means for measuring the spectrum of the band of radiation which has interacted with the sample is made on the opposite side of the sample as the at least one optical power source, so that the estimated radiance transfer factor matrix is the transmissivity matrix.

25. An apparatus according to claim 22, wherein the illumination of the sample or the measurement of the spectrum of the band of radiation which has interacted with the sample employs a diffuse geometry.

26. An apparatus according to claim 22, wherein either the illumination of the sample or the measurement of the spectrum of the band of radiation which has interacted with the sample employs a directional geometry.

27. An apparatus according to claim 22, comprising means for measuring the color of the sample based on the radiance transfer factor.

28. An apparatus according to claim 22, the apparatus being arranged to estimate the apparent reflectance of the sample from the radiance transfer factor for at least one known state of illumination.

29. An apparatus according to claim 22, the apparatus being arranged to estimate the apparent reflectance of the sample for at least two different conditions of illumination, and its illuminator metamerism is evaluated with respect to a reference sample of known apparent reflectance in the same conditions of illumination.

30. An apparatus according to claim 22, the apparatus being arranged to estimate the color of the sample from the radiance transfer factor for at least one state of illumination corresponding to a standard illuminant, and expressed in a calorimetric coordinate system.

31. An apparatus according to claim 22, the apparatus being arranged to estimate the brightness of the sample from the radiance transfer factor for at least one known state of illumination, and expressed in a standard brightness scale.

32. An apparatus according to claim 22, wherein the means for measuring the spectrum is arranged to measure the spectral power distribution.

33. An apparatus according to claim 22, wherein the means for estimating are arranged to estimate radiance transfer factor for both the fluorescent and non-fluorescent samples.

34. An apparatus according to claim 22, wherein the spectrum of the optical radiation of the optical power source is continuous in the optical band.

35. An apparatus according to claim 22, wherein the illumination state is a random variable of the spectral power distribution.

36. An apparatus according to claim 22, comprising means for controlling the variation of the illumination state deterministically.

37. An apparatus according to claim 22, wherein the means for estimating the radiance transfer factor are arranged to use least-squares estimation or constrained least-squares estimation.

38. An apparatus according to claim 22, wherein the means for estimating the radiance transfer factor are arranged to set to zero the elements of the estimated radiance transfer factor matrix which are negative or which correspond to physically impossible transitions.

39. An apparatus according to claim 22, wherein the means for estimating the radiance transfer factor matrix B use the following least-squares method:
B=RS^{T}(SS^{T})⁻¹,
where R is the measured spectral power distribution of the sample beam in each of three instants and S is the measured spectral power distribution of the reference beam at the same instants, and B is the radiance transfer factor matrix.

40. An apparatus according to claim 22, wherein the least-squares estimate of the radiance transfer factor matrix B is in the form:
$$B = diag ( B ) + {\sum }_{i = 1}^{N} {u}_{i} {v}_{i}^{T}$$
where uᵢ and vᵢ are column vectors which respectively describe the excitation and emission spectra of fluorescence relation i, and N is the number of fluorescent relations.

41. An apparatus according to claim 40, wherein the means for estimating of the radiance transfer factor matrix B is arranged to perform the estimation with partial least-squares regression, principal components regression, ridge regression, continuum regression or canonical correlation analysis.

42. An apparatus according to claim 22, wherein the means for estimating of the radiance transfer factor matrix B is arranged to form the least-squares estimate of the radiance transfer factor matrix B by partial least-squares regression or by principal components regression or by canonical correlation analysis.

43. An apparatus according to claim 22, wherein the means for performing the reference measurements are arranged to perform the measurements at least partially in a different optical band than the measurements of the sample.
